(19) United States
(12) Patent Application Publication
(10) Pub. No.: US 2007/0217372 A1
(43) Pub. Date: Sep. 20, 2007

(54) System and method for distributing data in dedicated short-range communication system

(76) Inventors: Paul E. Gorday, West Palm Beach, FL (US); Thomas V. D'Amico, Inverness, IL (US)

Correspondence Address: MOTOROLA, INC., 1303 EAST ALGONQUIN ROAD, IL01/3RD, SCHAUMBURG, IL, 60196, US

(21) Appl. No.: 11/375,234

(22) Filed: Mar. 14, 2006

(51) Int. Cl. H04Q 7/24

(52) U.S. Cl. 370/338

(57) ABSTRACT

A data distribution system includes a controller communicatively coupled to an origin. A plurality of mobile units capable of storing, receiving, and communicating data pass within communication range of the origin. The controller has data configured for a destination, but the destination is communicatively unlinked from the controller. To communicate the data to the destination, the controller selects a mobile unit passing in range of the origin and communicates the data. The mobile unit has a route at least approximately allied with a geographical location of the destination. The mobile unit stores the data and continues traveling. The mobile unit communicates the data to the destination if in the communication range of the destination unit. Alternatively, the mobile unit communicates the data to another mobile unit if the other mobile unit has a route at least approximately more allied with the geographical location of the destination.

### FIELD OF THE DISCLOSURE

The subject matter of the present disclosure relates to a system and method for distributing data in a wireless communication system, and more particularly, relates to a system and method for distributing data, such as application, program, and control data, to unlinked remote units using mobile units in a Dedicated Short-Range Communication (DSRC) System.

### BACKGROUND OF THE DISCLOSURE

Wireless communication systems are known in the art. Some examples of wireless communication systems are disclosed in U.S. Patent Nos. 6,246,883 and 6,580,981 and in U.S. Patent Application Publications

2003/0120826 and 2004/0203836. A DSRC system is one type of wireless communication system. In a DSRC system, information can be wirelessly transferred from vehicle-to-vehicle, vehicle-to-roadside, and roadside-to-vehicle. For example, roadside units in the DSRC system are fixed infrastructure nodes that broadcast information (e.g., traffic control, road hazard alerts, electronic road signs, advertising, and map/navigation data) to passing vehicles or collect information (e.g., vehicle identification, traffic flow rate, or sensor data) from passing vehicles.

In the DSRC system, a dedicated control link, which can be wired or wireless, is used to program and manage the roadside units. When roadside units are installed, for example, the roadside units are connected to such a dedicated control link so that a central system can transfer data to and from the units. Unfortunately, configuring the roadside units for a dedicated control link can involve significant costs. If roadside units are installed without a dedicated control link, however, service technicians must manually perform any updates or other data transfers to the roadside units. Accordingly, any potential large-scale use of roadside units makes manual control of the units by service technicians impractical.

Thus, the subject matter of the present disclosure is directed to overcoming, or at least reducing the effects of, one or more of the problems set forth above.

### BRIEF DESCRIPTION OF THE DRAWINGS

The present disclosure will be best understood with reference to a detailed description, which follows, when read in conjunction with the accompanying drawings, in which:

FIG. 1 illustrates an embodiment of a wireless communication system according to certain teachings of the present disclosure;

FIG. 2 illustrates an embodiment of an in-vehicle unit relative to remote units of the wireless communication system of FIG. 1;

FIG. 3 illustrates a process of operating the wireless communication system of the present disclosure; and

FIG. 4 illustrates a process of routing data in the wireless communication system of the present disclosure.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

System and methods are disclosed for distributing data in a wireless communication system, such as a DSRC System. In an embodiment of a data distribution method, data is configured for communication to a remote unit having a geographical location. The remote unit is communicatively unlinked to an origin of the configured data. Mobile units pass within communication range of the origin, and a first mobile unit is selected from the passing mobile units to carry the configured data. The first mobile unit is selected because it has a first route at least approximately allied with the geographical location of the remote unit. Once the first mobile unit is selected, the origin communicates configured data to the first mobile unit, and the first mobile unit stores the communicated data. The first mobile unit continues traveling and communicates the data to the remote unit if the first mobile unit comes into communication range of the remote unit. Alternatively, the first mobile unit communicates the data to a second mobile unit if the second mobile unit has a second route that is at least more allied with the geographical location of the remote unit than the route of the first mobile unit.

In an embodiment of a data distribution system, a controller has data configured for communication to a destination unit, but the destination unit is communicatively unlinked to the controller. To communicate the data to the destination unit, the controller is communicatively coupled to an origin of configured data. A plurality of mobile units capable of storing, receiving, and communicating data pass within communication range of the origin. The controller selects a mobile unit from those passing in communication range of the origin to carry the configured data. The mobile unit is selected because it has a route at least approximately allied with the geographical location of the destination unit. The controller communicates the configured data to the selected mobile unit, which in turn stores the communicated data and continues traveling. If the mobile unit comes into communication range of the destination unit, the mobile unit communicates the stored data to the destination unit. Alternatively, the mobile unit communicates the stored data to a second mobile unit in communication range of the first mobile unit if the second mobile unit has a second route at least approximately more allied with the geographical location of the destination unit than the route of the first mobile unit.

In another embodiment of a data distribution, data is configured to program a remote unit having a geographical location. The remote unit is communicatively unlinked to an origin of configured data. To communicate the data from the origin to the remote unit, a mobile unit passing within communication range of the origin is selected to carry the configured data. Once communicated, the selected mobile unit stores the data and continues traveling. As it travels, the mobile unit determines whether it has come into communication range of the remote unit. When in range, the mobile unit communicates the data to the remote unit, and the data is used to program the remote unit.

The foregoing is not intended to summarize each potential embodiment or every aspect of the present disclosure. Let us now refer to the figures to describe the subject matter of the present disclosure in detail.

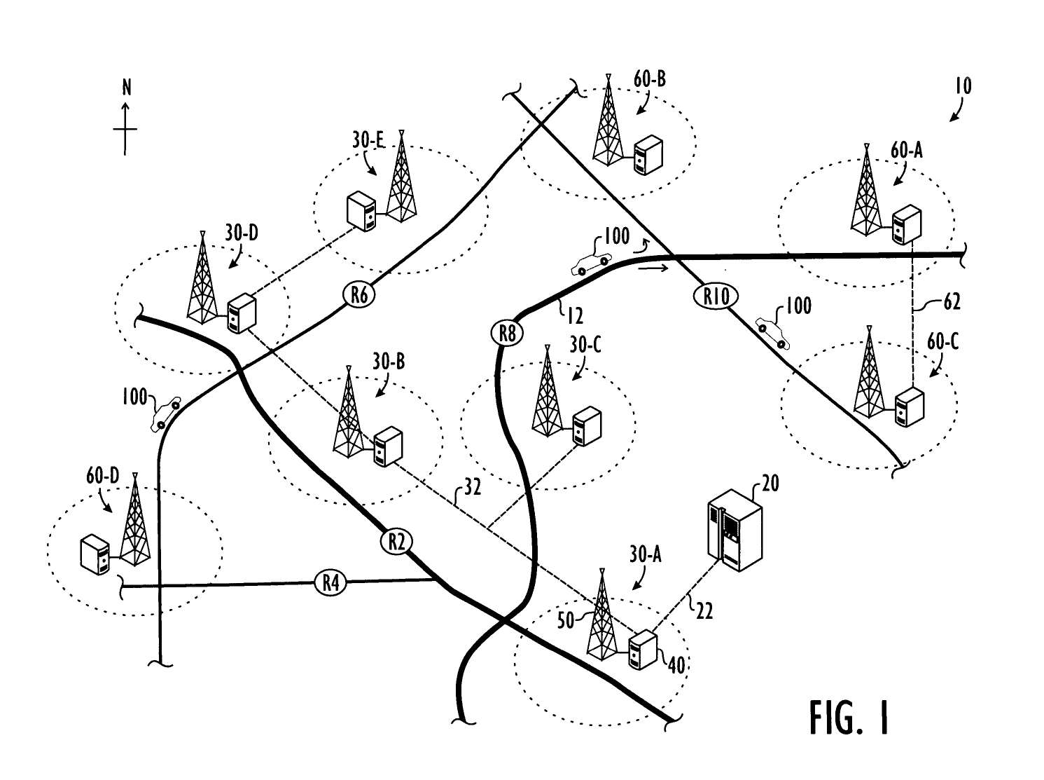

Referring to FIG. 1, a data distribution system 10 according to certain teachings of the present disclosure is schematically illustrated. The data distribution system 10 includes a system controller 20, a plurality of wireless communication units 30 and 60, and a plurality of mobile units 100. In the present embodiment and in the context of the present disclosure, the data distribution system 10 is a DSRC system. Accordingly, the mobile units 100 are installed in vehicles that travel on roads or the like 12. The wireless communication units 30 and 60 are distributed throughout a geographic area and form part of a fixed or portable infrastructure for DSRC with the mobile units 100. It will be appreciated that the data distribution system 10 can include more or less components than depicted in FIG. 1 and can be used in various implementations, such as city streets, roads, state highways, interstates, etc.

The system controller 20 controls the overall operation of the wireless communication system 10 and can store program data, control data, applications, traffic information, accounts, or other forms of data and information relevant to the operation and management of the system 10. The system controller 20 can be connected to one or more of the wireless communication units (e.g., unit 30-A and unit 30-C) by direct control links 22, which can be wired or wireless. In addition, the system controller 20 can be connected to one or more of the other wireless communication units (e.g., units 30-B, 30-D, and 30-E) by indirect control links 32, which can be wired or wireless. The communication units 30 connected by the controls links 22 and 32 are referred to herein as linked units 30.

Each wireless communication unit 30 and 60 includes a local controller 40 and an antenna 50. The local controller 40 includes a memory for storing applications and other relevant data. The antenna 50 is capable of short-range wireless communication within a communication range, which is schematically depicted by dashed lines in FIG. 1. The antenna 50 can be any commonly used in the art and can use frequencies and standards common to a DSRC system or similar frequencies and standards, such as IEEE 802.11 p.

The system controller 20 uses the communication units 30 and 60 to broadcast various forms of information, such as traffic control, road hazard alerts, Amber alerts, data for electronic road signs, data for advertising, navigation information, etc., to passing vehicles. Using the control links 22 and 32, the system controller 20 can also send data to program and control the linked units 30. The program and control data can include applications, software updates, and the like to be implemented by the local operating units 40 of the linked units 30.

In addition, the system controller 20 uses the communication units 30 and 60 to collect various forms of information from passing vehicles. For example, the collected data can include vehicle identification information, traffic flow rates, and various forms of sensor data. The data collected by the linked units 30 is communicated to the system controller 20 using the control links 22 and 32.

Some of the communication units (e.g., units 60-A, 60-B, and 60-C), are not communicatively connected to the system controller 20. These unlinked units 60 (referred to forthwith as remote units) are not linked to the system controller 20 by control links. These remote units 60 may be used to reduce the costs of the system 10 because the remote units 60 can be placed in areas where wired connections are costly or impractical or where wireless coverage is poor or unavailable.

The data distribution system 10 can readily manage any linked units 30 using the control links 22 and 32. To manage the remote units 60, however, the data distribution system 10 uses the mobile units 100 to transfer data to and from the unlinked units 60. For example, the system 10 can have several remote units 60, and the system controller 20 may use one or more linked units (e.g., unit 30-A) to communicate data with passing mobile units 100 and to transfer the data to and from the remote units 60. In this way, the system controller 20 uses the DSRC links between one or more linked units 30 and one or more mobile units 100 to send and receive program and control data and other data to and from remote units 60.

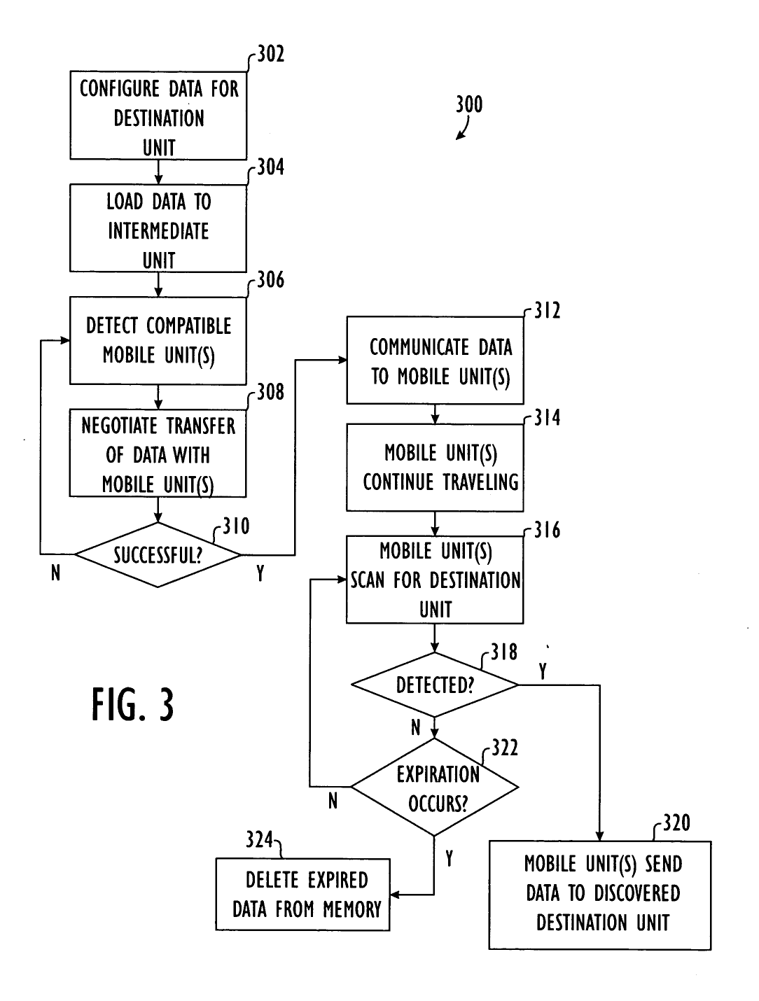

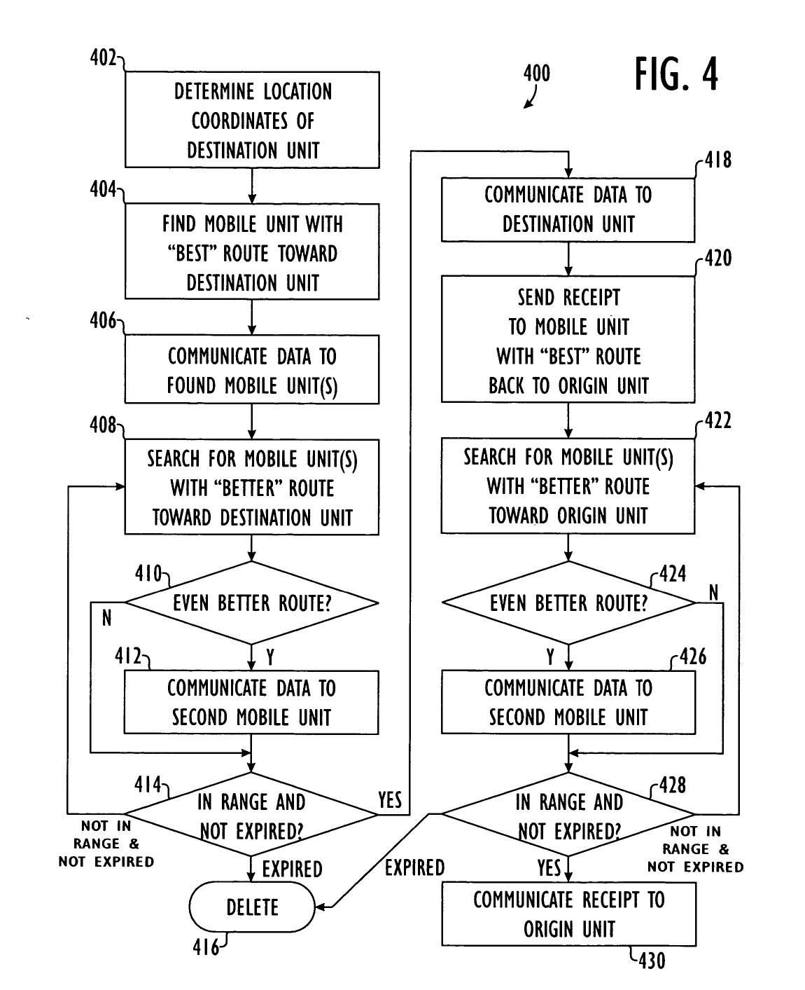

A brief example of how the system controller 20 sends data to the remote units 60 will now be discussed. More detailed discussion of this process is provided below with reference to FIGS. 3 and 4. The system controller 20 communicates data to at least one linked unit, such as linked unit 30-A, using a control link 22. In one embodiment, the data can be configured for generic broadcast to one or more destination, such as remote units 60-A, 60-B, 60-C, etc., with which mobile units 100 happen to come within communication range. In the present embodiment, this data is particularly targeted for delivery to one or more destinations, such as remote unit 60-A, and the data can be configured for the one or more particular destinations having geographical locations in the area of the system 10. The data can also be configured to program or control the remote unit 60-A, can be an application or software update for the remote unit 60-A, or can be any other information to be used by the remote unit 60-A.

From the linked unit 30-A, the data can be further relayed by another control link 32 to another linked unit, such as linked unit 30-C, which is chosen to act as an origin of the data. Preferably, the linked unit 30-C chosen to act as the origin has a location that is at least approximately proximate to the remote unit 60-A that is the destination for the data. For example, the linked unit 30-C may be on the same route, road, or in the same area as the designated remote unit 60-A.

Mobile units 100 pass within communication range of the linked unit 30-C, and one or more of the mobile units 100 are selected to carry the data for delivery to the remote unit 60-A. In one embodiment, the one or more mobile units 100 may be randomly selected to carry the data. Alternatively, the one or more mobile units 100 can be selected based on one or more selection criteria, examples of which are discussed in more detail below. Selection of the mobile units 100 can be made by the mobile unit 100, the local operating unit 40, the system controller 20, or any combination thereof.

Once selection has been made, the linked unit 30-C communicates the data to the one or more selected mobile units 100. In turn, the selected mobile units 100 store the data, and the selected mobile units 100 then serve as carriers of the data. The storage of the data is preferably limited until either the mobile unit 100 is within the communication range of the remote unit 60-A or until one or more expiration criteria is met. Examples of expiration criteria are discussed in more detail below. When one of the selected mobile units 100 is within communication range of the remote unit 60-A, the mobile unit 100 communicates the stored data to the remote unit 60-A. After communication, the mobile unit 100 preferably deletes the data after successfully transferring the data to the remote unit 60-A.

As discussed briefly above, the system controller 20 can receive data (e.g., vehicle identification, traffic information, etc.) from a remote unit 60. Communicating data to the system controller 20 from a remote unit 60 can use the same techniques discussed above, albeit in reverse. For example, the local controller 40 at a remote unit (e.g., remote unit 60-D) configures data to send to the system controller 20. The remote unit 60-D then selects one or more mobile units 100 passing within communication range to carry the data. The selection can be made randomly or according to the forms of selection criteria discussed below. After selecting, the remote unit 60-D communicates the data to the mobile units 100, which store the data and continue traveling.

As a mobile unit 100 carrying the data travels along its route, it determines when it is in communication range of a communication unit 30 or 60. When in communication range, the mobile unit 100 preferably determines whether the unit 30 or 60 is linked to the system controller 20. For example, the mobile unit 100 and the communication unit 30 or 60 can exchange messages, or the mobile unit 100 may recognize whether a unit 30 or 60 is linked based on stored information. If the communication unit is linked, the mobile unit 100 communicates the data to the linked unit (e.g., linked unit 30-D) and deletes the data after successful communication. The linked unit 30-D then sends the data via control links 22 and 32 to the system controller 20. It will be appreciated that the data could also be configured for transfer from the remote unit 60-D to another remote unit 60 or to a linked unit 30. In such an instance, the system controller 20 and/or the various local operating units 40 can handle the routing of the data between units 30 and 60 using the techniques disclosed herein.

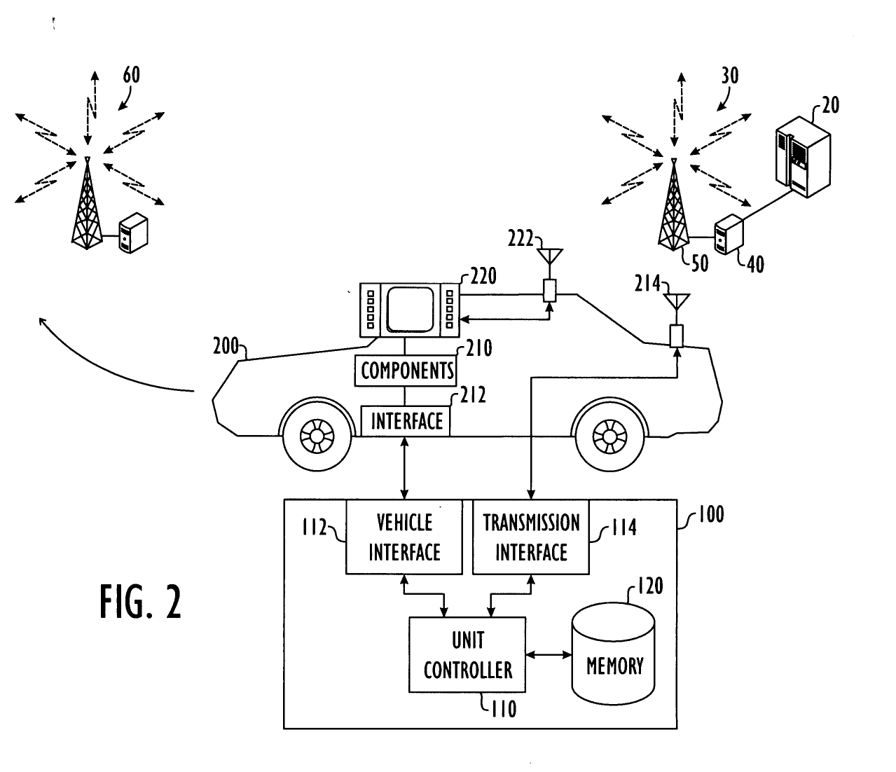

Now that details of the wireless communication system 10 and its operation have been discussed, we now turn to FIG. 2, in which an embodiment of a mobile unit 100 is schematically illustrated. In the present embodiment, the mobile unit 100 is an on-board component of a vehicle 200. The mobile unit 100 includes a unit controller 110, which can include conventional electronic components used for similar systems used on board vehicles. The unit controller 110 is coupled to the memory 120, which stores data to be carried by the mobile unit 100.

The unit controller 110 is also coupled to a vehicle interface 112 that is in turn coupled to an interface 212 and components 210 of the vehicle 200. The vehicle interface 112 can include an On-Board Diagnostic connection or a connection to a data bus of the vehicle 200. The unit controller 110 is also coupled to a transmission interface 114 that is in turn connected to a transceiver 214 of the vehicle 200. The transceiver 214 is used for DSRC with communication units 30 and 60.

In one embodiment, the vehicle 200 includes a navigation unit 220 to which the mobile unit 100 can couple via the vehicle interface 112. The navigation unit 220 can be an on-board navigation device, a memory storing route information, a Global Positioning System (GPS) device, or any other device known in the art that can provide the mobile unit 100 with geographical information, route information, heading, vehicle metrics (e.g., speed and direction), or other information for the vehicle 200. For example, the vehicle 200 can have a GPS unit 222 coupled to the navigation system 220 so that GPS-based information can be provided to the mobile unit 100. In an alternative embodiment, the mobile unit 100 and the navigation unit 220 can be combined components of an integrated system in the vehicle 200.

Details of the operation of the mobile unit 100 will now be discussed. The mobile unit 100 can send and receive data to and from the communication units 30 and 60 using the transceiver 214 when in range of the antennas 50. As discussed above, the data can be configured for a destination, such as remote unit 60. Accordingly, the local controller 40 of the linked unit 30 acting as the origin of data can determine whether the vehicle 200 has a route or heading toward the remote unit 60. To make this determination, the mobile unit 100 can obtain route information from the navigation unit 220 of the vehicle 200 and can transmit that route information to the local controller 40 of the linked unit 30. If the route information indicates that the vehicle 200 has a route or heading towards the remote unit 60, the linked unit 30 transfers the data to the mobile unit 100, where it is stored in memory 120.

As the vehicle travels 200, the mobile unit 100 determines whether it is in communication range of the remote unit 60. For example, the mobile unit 100 can compare its current geographical location obtained by the GPS unit 222 to the geographical location of the remote unit 60 to determine whether it is in range. Alternatively, the mobile unit 100 can scan with the transceiver 214 to detect the signal and address of the remote unit 60 when it is in communication range. Once in communication range, the mobile unit 100 sends the data in memory 120 to the remote unit 60 using the transceiver 214.

Now that details of the data distribution system 10 of FIG. 1 and the mobile unit 100 of FIG. 2 have been discussed, we now turn to further details of how the disclosed data distribution system 10 is operated. Referring to FIG. 3, a process 300 of operating the data distribution system of the present disclosure is illustrated in flow chart form. In the discussion that follows, reference is concurrently made to the reference numerals for components of FIGS. 1 and 2. Initially, a system operator or automated update system uses the system controller 20 to configure data to send to an unlinked, remote unit (e.g., remote unit 60-A that is accessible only through its DSRC link and not a dedicated control link) (Block 302). As used herein, this remote unit 60-A is referred to as the destination unit. The data to be sent can be program data, control data, application data, or any other data or information relevant to a particular implementation.

The system controller 20 then delivers the data to an intermediate unit (e.g., linked unit 30-C), which acts as an origin of the configured data (Block 304). As used herein, this intermediate, linked unit 30-C is referred to as the origin unit. In one embodiment, a network map, the GPS coordinates, or other Geographic Information System (GIS) is used to determine which of the linked units 30 of the system 10 should receive the initial upload and act as the origin of the configured data. The origin unit 30-C may or may not be on the same road or highway as the destination unit 60-A, but the system controller 20 is capable of directly or indirectly accessing the unit 30-C with one or more dedicated control links 22 and 32. For purposes of diversity, it will be appreciated that the system controller 20 can use more than one unit as the origin of the configured data.

The origin unit 30-C is preferably at least proximate to the geographical location of the destination unit 60-A. As used herein, to be at least proximate to the geographic location of the destination unit 60-A refers to being on the same route with the destination unit 60-A, being nearby the road adjacent the destination unit 60-A, being on a road connected to the road adjacent the destination unit 60-A, being within a specific radius of the destination unit 60-A, etc. In the example of FIG. 1, the origin unit 30-C is on the same road R8 as the destination unit 60-A.

After the configured data has been uploaded, the origin unit 30-C detects one or more compatible mobile units 100 passing within the communication range of the unit 30-C (Block 306). The origin unit 30-C then selects one or more of the mobile units 100 and negotiates the transfer of data with the mobile units 100 (Block 308). In one embodiment of the negotiation process, the system controller 20 and/or local controller 40 can determine route information for the mobile units 100 by querying the passing mobile units 100 for route information and receiving route information transmitted from the mobile units 100 responding to the query. In another embodiment, the mobile units 100 can freely broadcast route information, and the system controller 20 and/or local controller 40 can receive the route information using one or more of the units 30 and 60.

During the negotiation process of Block 308, a passing mobile unit 100 may opt to reject the transfer of data because the mobile unit 100 has limited resources, such as memory, communication capabilities, processing features, etc. During the negotiation process of Block 308, transfer of the data to a passing mobile unit 100 may be rejected if the geographical location of the destination unit 60-A where the data is to be delivered is inconsistent with route information of the passing mobile unit 100. In this instance, the mobile unit 100 can access route information located in the navigation unit 220 or other component 210 of the vehicle 200. The route information can be the speed, the direction, the location, the route, the heading, etc. of the passing mobile unit 100. The route information obtained from the navigation unit 220 is compared to the geographical location of the destination unit 60-A. The unit controller 110 of the mobile unit 100, the local controller 40, and/or the system controller 20 can be used to compare route information and the geographical location of the destination unit 60-A.

If the route information of the mobile unit 100 is not at least approximately allied with the geographical location of the destination unit 60-A, then transfer of the data to the mobile unit 100 may be rejected. As used herein, for route information to be at least approximately allied with the geographic location of the destination unit 60-A, the mobile unit 100 may be on the same road as the destination unit 60-A, may be near a road adjacent the destination unit 60-A, may be on a road connected to a road adjacent the destination unit 60-A, may be traveling along a road that passes within a geographical zone of the destination unit 60-A, may be traveling on a road heading toward the destination unit 60-A, may be traveling on a lane of a road exiting to another road toward the destination unit 60-A, etc. The precision required to determine whether route information is at least approximately allied with the geographic location of the destination unit 60-A can be configured for a particular implementation, and the required precision can be based on probability, the geographical area, the number and types of roads, the number and proximity of communication units 30 and 60, and other factors evident to one skilled in the art.

During the negotiation process of Block 308, a location or a direction of an antenna at the origin unit 30-C can alternatively be used to select which mobile unit 100 to receive the configured data. For example, the origin unit 30-C may have multiple antennas covering more than one lane of a road, highway, etc. For example, first lanes (i.e., a left lane) may be more likely to continue along the current highway, while second lanes (e.g., a right lane near an exit of a highway interchange) may be more likely to exit to another highway. If the configured data is intended for a remote unit 60 along the current highway, the antenna adjacent the left lane of the highway is used to transfer data to those vehicles 200 having compatible mobile units 100 passing near this antenna. Likewise, if the configured data is intended for a remote unit 60 along an adjoining highway, the antenna adjacent the right lane of the highway is used to transfer data to those vehicles 200 having compatible mobile units 100 passing near this antenna. Selecting which mobile unit 100 based on a location or a direction of an antenna at the origin unit 30-C can involve an assessment of the probability that a vehicle 200 will travel a route allied with the location of the destination unit 60-A and may not require communicating route information between the mobile unit 100 and the origin unit 30-C.

Continuing with the operation of the system 10, the origin unit 30-C determines whether the negotiations are successful (Block 310). If they are not, the origin unit 30-C returns to detecting compatible mobile units 100 at Block 306. If successful, the origin unit 30-C transfers the data to one or more selected mobile units 100 of the passing vehicles 200 (Block 312). The data may be transferred to multiple mobile units 100 for the purposes of redundancy and diversity. Alternatively, a large amount of data to be transferred may be divided among several smaller data transfers to several mobile units 100. The transferred data preferably includes routing information, such as the network addresses in the system 10 and the geographical location of the destination unit 60-A and the origin unit 30-C.

In one embodiment, the transferred data includes criteria governing expiration of the data. The expiration criteria may be suitable for data carried by the mobile units 100 that is configured for generic broadcast to any remote unit 60 of which the mobile unit 100 happens to come within communication range. In addition, the expiration criteria may be suitable for data configured for delivery to a specific remote unit 60 in the event the mobile unit 100 changes routes, stops, or otherwise does not come within communication range of the remote unit 60.

In another embodiment, the expiration criteria include a time limit for the transferred data. For example, timing information, such as a transaction time stamp and an expiration time, can be sent to the mobile unit 100 along with the transferred data. Based on the time limit, the mobile unit 100 can delete expired data from its memory 120 in the event the mobile unit 100 does not come within communication range of the destination unit 60-A for whatever reason.

For example, the mobile unit 100 in FIG. 1 traveling along route R8 may be carrying data for destination unit 60-A. The mobile unit 100 may have been selected randomly or selected based on its current direction along route R8. Regardless of how it was selected, the mobile unit 100 can take one of three routes. For instance, the mobile unit 100 can continue in an easterly direction on route R8 in which case the mobile unit 100 will eventually come within communication range of the destination unit 60-A and can eventually transfer the data to the destination unit 60-A. The mobile unit 100, however, can alternatively take a northerly or southerly direction on route R10 in which case the mobile unit 100 will not come within communication range of the destination unit 60-A. Accordingly, the data configured for the destination unit 60-A will expire after the time limit, and the mobile unit 100 will delete the data from its memory 120. In this respect, however, the data configured in the message for the destination unit 60-A may also be applicable to another unlinked unit, such as remote unit 60-B or 60-C. Accordingly, in some embodiments, the data transferred to a mobile unit 100 can specify one or more remote units 60 as destinations for delivery of the data.

In addition, some of the remote units 60, although not linked to the system controller 20, may instead be linked to other remote units 60. In FIG. 1, for example, the destination unit 60-A is linked with another remote unit 60-C, although both of these units 60-A and 60-C are not linked with the system controller 20 by a control link. In this situation, data configured for delivery to the destination unit 60-A can be intermediately delivered to the associated remote unit 60-C by a mobile unit 100 traveling in a southerly direction on route R10 and sent by link 62 to the destination unit 60-A.

In yet another embodiment, the expiration criteria can be a distance limit associated with the data being carried by a mobile unit 100. Based on the distance limit, the mobile unit 100 deletes data from its memory 120 if the distance of the mobile unit 100 from the destination unit 60-A meets or exceeds the distance limit. Alternatively, the distance limit can specify the travel distance that the mobile unit 100 can carry the data. If the mobile unit 100 travels beyond this travel distance, then the data can be deleted. In addition to expiration criteria, the data preferably includes encryption to maintain integrity of the data, to maintain security of the data distribution system 10, to restrict access to the units 30, 60, and 100, and to achieve other possible security objectives.

After accepting the transmitted data at Block 312, the mobile unit 100 stores the data in memory 120, and the vehicle 200 containing the mobile unit 100 continues traveling (Block 314). While traveling, the mobile unit 100 scans for the destination unit 60-A (Block 316) and determines whether the destination unit 60-A is detected or within communication range (Block 318). The scanning and detection process can use communication transmissions and/or GPS location information to determine whether the mobile unit 100 is within communication range of the destination unit. For example, the mobile unit 100 can communicate messages having the network address of the destination unit 60-A to detect whether it is in range. Alternatively, the mobile unit 100 can determine its current location (e.g., GPS coordinates) and can compare its current location to the geographical location of the destination unit 60-A to determine whether the mobile unit 100 is in range.

If in range, the mobile unit 100 transfers data to the destination unit 60-A (Block 320). If not in range, the mobile unit 100 continues scanning for the destination unit 60-A by returning to Block 316. Before continuing to scan, however, the mobile unit 100 also periodically checks whether pending data stored in its memory 120 has expired (Block 322). If the data has expired either because of too much time or distance for example, the mobile unit 100 deletes the expired data from its memory 120 (Block 324).

In the process of FIG. 3, it will be appreciated that a single mobile unit 100 may carry data designated for one or more remote units 60 at a time and that multiple mobile units 100 may carry data designated for a single remote unit 60. Furthermore, it will be appreciated that a reverse of the above process 300 can be used when a remote unit 60 needs to deliver data to the system controller 20 or to another communication unit 30 and 60.

As noted previously, the data distribution system 10 preferably selects the mobile units 100 to carry data so that routing of the data can be more efficient. Because the data can be directed to a specific destination unit 60-A having a known geographical location, the system controller 20 can intelligently route the data so that the data converges on its desired destination unit 60. For example, the data distribution system 10 can relay the data between passing mobile units 100 and fixed communication units 30 and 60 using route information of the mobile units 100 and GPS or other geographical information of the communication units 30 and 60.

Referring to FIG. 4, a process 400 for routing data to a destination unit 60-A is illustrated in flow chart form. In the discussion that follows, reference is concurrently made to the reference numerals for components of FIGS. 1 and 2. In the present process 400, routing of the data is enhanced by using geographical information of an area so that data can be relayed between multiple mobile units 100 and communication units 30 and 60 along the most appropriate routes (i.e., roads, highways, etc.) in the area. This approach may require only one or just a few copies of configured data to be routed at the same time to a destination unit 60-A and may require one acknowledgment to be routed back to the system controller 20 to confirm delivery.

In the process 400, the location of the destination unit 60-A is first determined (Block 402). The location can be GPS coordinates or other geographical information of any other GIS known in the art. The system controller 20 then finds one or more mobile units 100 with the “best” route toward the location of the destination unit 60-A (Block 404). In general, the “best” route is at least approximately allied with the location of the destination unit 60-A. Determination of the “best” route is based on analysis of route information obtained from the mobile units 100 and analysis of geographical information of routes in the area. For example, the geographical information can include maps, traffic information, and similar information of the area. The geographical information can enhance delivery of the data by enabling routing algorithms to overcome obstacles such as one-way streets, changes in road directions, traffic, etc.

The system controller 20 then communicates one or more messages of configured data to one or more mobile units 100 having the “best” routes (Block 406). Each mobile unit 100 stores the data and starts a process for detecting whether it has come within communication range with the destination unit 60 according to the process previously described. According to the present process 400, however, the mobile units 100 carrying the data also search for other mobile units 100 having “better” routes towards the location of the destination unit 60-A (Block 408). Again, determination of the “better” route is based on an analysis of route information obtained from other mobile units 100 and analysis of geographical information of the area.

To detect other mobile units 100 having “better” routes, the mobile unit 100 carrying the data determines route information for one or more other mobile units 100 passing within communication range of the carrying mobile unit 100. When route information is determined for another mobile unit 100 in range, the carrying mobile unit 100 compares the determined route information with its own current route and with the location of the destination unit 60-A (Block 410). The carrying mobile unit 100 then selects the other mobile unit 100 to carry the data if the route of the other mobile unit 100 is at least approximately more allied with the geographical location of the destination unit 60-A than the current route of the carrying mobile unit 100.

The carrying mobile unit 100 can determine route information of other mobile units 100 by querying mobile units 100 in communication range of its transceiver 214 and receiving route information transmitted from the mobile units 100 responding to the query. Alternatively, the other mobile units 100 may freely broadcast their route information with their transceivers 214, and the carrying mobile unit 100 may receive the broadcast route information from those mobile units 100 in communication range.

If a mobile unit 100 is found with a “better” route, then the carrying mobile unit 100 communicates configured data to this second mobile unit 100 (Block 412). Communicating the data may include return of an acknowledgement message to the sending mobile unit 100 to ensure successful delivery of the data between the mobile units 100. In addition, the sending mobile unit 100 may delete the data from its memory 120 upon successful transmission to the second mobile unit 100, or the sending mobile unit 100 may continue to store the data in memory 120 and search for the destination unit 60-A and other mobile units 100.

Regardless of whether a second mobile unit 100 is found with a “better” route, the current carrying mobile unit 100 determines whether it is in communication range of the destination unit 60-A and determines whether the data is expired (Block 414). If the data has expired at Block 414, the mobile unit 100 deletes it from memory 120 (Block 416). If the mobile unit 100 is not in range but the data has not yet expired, the mobile unit 100 continues searching for a mobile unit 100 with a “better” route (Block 408), and the steps of Blocks 408 through 414 may be repeated as needed until the data expires, the mobile unit 100 finds another mobile unit 100 with a “better” route, or the mobile unit 100 comes within range of the destination unit 60-A.

If the carrying mobile unit 100 is in range of the destination unit 60-A and the data has not expired, then the mobile unit 100 communicates the data to the destination unit 60-A (Block 418). Communicating the data may include return of an acknowledgement message to the sending mobile unit 100 to ensure successful delivery of the data between the mobile units 100. After successful communication of the data, the destination unit 60-A sends a receipt message to one or more mobile units 100 having the “best” routes back to any unit 30 linked to the system controller 20 or to the origin unit 30-C where the data originated (Block 420). The receipt message includes the location of the origin unit 30-C. The mobile units 100 carrying the receipt message also search for other mobile units 100 with “better” routes towards the location coordinates of the origin unit 30-A (Block 422). Again, the determination of the “better” route is based on an analysis of route information obtained from other mobile units 100 and analysis of map information of routes in the geographic area.

If another mobile unit 100 is found with a “better” route (Block 424), then the carrying mobile unit 100 communicates the receipt message to a second mobile unit (Block 426). Communicating the receipt message may include transmission of an acknowledgement message to ensure successful transmission. Regardless of whether a second mobile unit 100 is found with a “better” route, the current carrying mobile unit 100 determines whether it is in communication range with the origin unit 30-C and whether the receipt message has expired (Block 428). If the mobile unit 100 is not in range but the receipt message has not yet expired, the mobile unit 100 continues with searching for a mobile unit with a “better” route (Block 422), and the steps of Blocks 422 through 428 can be repeated as necessary. If the message has expired, however, the mobile unit 100 deletes it from memory (Block 416). If the mobile unit 100 is in range of the origin unit 30-C and the message has not expired, then the mobile unit 100 communicates the receipt message to the origin unit 30-C (Block 430).

The foregoing description of the embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A data distribution method, comprising:
configuring data for communication to a remote unit having a location, the remote unit communicatively unlinked to an origin of the configured data;
selecting a first mobile unit passing within communication range of the origin, the first mobile unit having a first route at least approximately allied with the location of the remote unit;
communicating configured data from the origin to the first mobile unit; and
communicating configured data from the first mobile unit (1) to the remote unit if the first mobile unit is within communication range of the remote unit or (2) to a second mobile unit if the second mobile unit has a second route that is at least approximately more allied with the location of the remote unit than the first route.

2. The method of claim 1, wherein the act of selecting comprises:
determining route information for a plurality of mobile units;
comparing determined route information with the location of the remote unit; and
selecting the first mobile unit from the plurality of mobile units based on the comparison.

3. The method of claim 2, wherein the act of determining route information for the mobile units comprises:
querying the mobile units for route information; and
receiving route information transmitted from the mobile units responding to the query.

4. The method of claim 2, wherein the act of determining route information for the mobile units comprises:
broadcasting route information from the mobile units; and
receiving route information broadcast from the mobile units.

5. The method of claim 1, wherein the act of selecting the first mobile unit passing within communication range of the origin comprises:
determining, based on a location or a direction of an antenna, which direction a plurality of mobile units are traveling when within communication range with the antenna; and
selecting the first mobile unit as at least one of the mobile units having a direction at least approximately allied with the location of the remote unit.

6. The method of claim 1, wherein the act of communicating configured data from the first mobile unit to the second mobile unit comprises:
determining route information from one or more second mobile units passing within communication range of the first mobile unit;
comparing determined route information with the location of the remote unit and with the first route of the first mobile unit; and
selecting the second mobile unit as at least one of the second mobile units having a route that is at least approximately more allied with the location of the remote unit.

7. The method of claim 6, wherein the act of determining route information from the one or more second mobile units passing within communication range of the first mobile unit comprises:
querying the one or more second mobile units passing within communication range of the first mobile unit for route information; and
receiving, at the first mobile unit, route information transmitted from the second mobile units responding to the query.

8. The method of claim 6, wherein the act of determining route information from the one or more second mobile units passing within communication range of the first mobile unit comprises:
broadcasting route information from the second mobile units; and
receiving, at the first mobile unit, route information broadcast from the second mobile units within communication range of the first mobile unit.

9. The method of claim 1, wherein the act of configuring comprises assigning an expiration criterion to configured data, and wherein the method further comprises:
storing configured data at the first mobile unit when communicated from the origin;
determining at the first mobile unit whether the expiration criterion occurs; and
deleting configured data from the first mobile unit if the expiration criterion occurs before communicating configured data from the first mobile unit to the remote unit or to the second mobile unit.

10. A data distribution system, comprising:
a plurality of mobile units capable of receiving and communicating data;
a destination unit having a location and having a communication range;
a communication device having a communication range; and
a controller communicatively coupled to communication device, the controller configured to:
select a first mobile unit from the mobile units passing within the communication range of the communication device, the first mobile unit having a first route at least approximately allied with the location of the destination unit, and
communicate data from the communication device to the first mobile unit,
wherein the first mobile unit is configured to communicate data (1) to the destination unit if the first mobile unit is within the communication range of the destination unit or (2) to a second mobile unit within communication range of the first mobile unit if the second mobile unit has a second route at least approximately more allied with the location of the destination unit than the first route.

11. The system of claim 10, wherein to select the first mobile unit, the controller is configured to:
determine route information from the mobile units passing within communication range of the communication device;
compare determined route information with the location of the destination unit; and
select the first mobile unit from the mobile units based on the comparison.

12. The system of claim 11, wherein to determine route information from the plurality of mobile units passing within communication range of the communication device, the controller is configured to:
query the mobile units for route information; and
receive route information transmitted from the mobile units responding to the query.

13. The system of claim 10, wherein to select the first mobile unit from the mobile units passing within communication range of the communication device, the controller is configured to:
determine, based on a location or a direction of an antenna, which direction the mobile units are traveling when within communication range with the antenna; and
select the first mobile unit as at least one of the mobile units having a direction at least approximately allied with the location of the destination unit.

14. The system of claim 10, wherein to communicate data from the first mobile unit to the second mobile unit, the first mobile unit is configured to:
determine route information from one or more second mobile units passing within communication range of the first mobile unit;
compare determined route information with the location of the destination unit and with the first route; and
select the second mobile unit as at least one of the mobile units having a second route that is at least approximately more allied with the location of the destination unit than the first route.

15. The system of claim 14, wherein to determine route information from the one or more second mobile units passing within communication range of the first mobile unit, the first mobile unit is configured to:
query the one or more second mobile units passing within communication range of the first mobile unit for route information; and
receive route information transmitted from the second mobile units responding to the query.

16. The system of claim 14, wherein to determine route information from one or more second mobile units passing within communication range of the first mobile unit, the first mobile unit is configured to:
broadcast route information from the second mobile units; and
receive route information broadcast from the second mobile units within communication range of the first mobile unit.

17. A data distribution method, comprising:
configuring data for communication to a remote unit having a first location, the data configured to program the remote unit, the remote unit communicatively unlinked to an origin of configured data;
selecting a mobile unit passing within communication range of the origin;
communicating configured data from the origin to the selected mobile unit;
determining whether the selected mobile unit is within communication range of the remote unit;
communicating configured data from the selected mobile unit to the remote unit when within communication range of the remote unit; and
programming the remote unit with communicated data from the selected mobile unit.

18. The method of claim 17, wherein the act of selecting comprises:
determining route information for one or more mobile units;
comparing determined route information with the first location of the remote unit; and
selecting one or more of the mobile units having a route at least approximately allied with the first location the remote unit.

19. The method of claim 17, wherein the act of configuring comprises assigning an expiration criterion to configured data, and wherein the method further comprises:
storing configured data at the selected mobile unit when communicated from the origin;
determining at the selected mobile unit whether the expiration criterion occurs; and
deleting stored data from the selected mobile unit if the expiration criterion occurs.

20. The method of claim 19, wherein the expiration criterion comprises at least one of the following:
a distance limit from the remote unit, wherein the act of determining at the selected mobile unit whether the expiration criterion occurs comprises: determining a second location of the selected mobile unit; and determining whether a distance between the first location of the remote unit and the second location of the selected mobile unit meets or exceeds the distance limit assigned to the stored data; or
a time limit, wherein the act of determining at the selected mobile unit whether the expiration criterion occurs comprises: determining a time value for the selected mobile unit; and determining whether the time value meets or exceeds the time limit assigned to the stored data.
